(19) United States
(12) Patent Application Publication
(10) Pub. No.: US 2013/0199381 A1
(43) Pub. Date: Aug. 8, 2013

(54) Food Dispensing Apparatus

(71) Applicant: Mark Gillett, Venice, FL (US)

(72) Inventor: Mark Gillett, Venice, FL (US)

(21) Appl. No.: 13/365,407

(22) Filed: Feb. 3, 2012

(51) Int. Cl. A23P 1/00

(52) U.S. Cl. 99/450.4

(57) ABSTRACT

A food dispensing apparatus for preparing a sandwich. The apparatus includes a housing including a bun pocket forming mechanism, a bun transfer member, and a pair of opposing driven rollers. The pocket forming mechanism includes a motor-driven articulating cutting disc which forms a food receiving slit into a bun as the bun transfer mechanism moves the bun into cutting engagement with the cutting disc. The rollers are adapted in size and spacing to receive and squeeze food from an elongated food package opened at a distal end thereof into the food receiving slot of the bun.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to food dispensing apparatus, and more particularly to a food dispensing apparatus which forms a slit or pocket in a bun and then dispenses prepared food from a sealed flexible tube into the slit within the bun.

2. Description of Related Art

Food dispensing apparatus come in a variety of forms. Some of these apparatus are designed to dispense food which is ready for opening and consumption while others dispense a fluid beverage into a cup also ready for consumption.

A number of additional prior art devices designed for various aspects of food preparation and consumption in a commercial setting are disclosed in the following U.S. patents.

U.S. Pat. No. 460,283 to Adler discloses a metallic ceiling. Shapiro et al. teach a ceiling panel for installation as a component of a matrix grid of similar panels which are capable of being installed directly on sheetrock ceilings in U.S. Pat. No. 7,134,249.

A decorative ceiling panel to be placed over and directly attached to an existing ceiling or wall surface is also disclosed by Shapiro in U.S. Patent Application Publication 2007/0011975. Herrmann teaches a lightweight and interlocking plastic ceiling tile system in U.S. Pat. No. 6,117,514.

A ceiling panel is taught by Halfaker in U.S. Pat. No. 4,437,287. U.S. Pat. No. 5,425,210 to Zafir discloses a composite insulated building panel.

A concealing trim assembly for a wall or ceiling panel system is taught by Gailey in U.S. Pat. No. 5,191,743. Widdowson teaches a prefabricated, insulated, metal wall panel in U.S. Pat. No. 3,797,190.

The foregoing examples of the related art and limitations related therewith are intended to be illustrative and not exclusive. Other limitations of the related art will become apparent to those skilled in the art upon a reading of the specification and a study of the drawings.

### BRIEF SUMMARY OF THE INVENTION

This invention is directed to a food dispensing apparatus for preparing a sandwich. The apparatus includes a housing including a bun pocket forming mechanism, a bun transfer member, and a pair of opposing driven rollers. The pocket forming mechanism includes a motor-driven articulating cutting disc which forms a food receiving slit into a bun as the bun transfer mechanism moves the bun into cutting engagement with the cutting disc. The rollers are adapted in size and spacing to receive and squeeze food from an elongated food package opened at a distal end thereof into the food receiving slot of the bun.

It is therefore an object of this invention to provide a food dispensing apparatus which slices or forms a slit into a fresh bun and then dispenses prepared food which may have been previously warmed by e.g. microwave, into the bun ready for consumption.

It is another object of this invention to provide a food dispensing apparatus having a unique bun slitting mechanism which facilitates the forming of a pocket within a fresh bun immediately prior to filling that pocket with fresh processed food from a flexible tubular container.

The following embodiments and aspects thereof are described and illustrated in conjunction with systems, tools and methods which are meant to be exemplary and illustrative and not limiting in scope. In various embodiments one or more of the above-described problems have been reduced or eliminated while other embodiments are directed to other improvements. In addition to the exemplary aspects and embodiments described above, further aspects and embodiments will become apparent by reference to the drawings and by study of the following descriptions.

### BRIEF DESCRIPTION OF THE SEVERAL VIEWS OF THE DRAWING(S)

FIG. 1 is a perspective view of the invention.

FIG. 2 is a section view in the direction of arrows 2-2 in FIG. 1.

FIG. 3 is a perspective view of a food package used in conjunction with the invention shown in FIG. 1.

FIG. 4 is a top plan view of FIG. 3.

FIG. 5 is a side elevation view of FIG. 4.

FIG. 6 is an end elevation view of FIG. 4.

FIG. 7 is a section view in the direction of arrows 7-7 in FIG. 4.

FIG. 8 is a top plan view of a bun pocket forming mechanism positioned ready for use with respect to a sandwich bun.

FIGS. 9 to 14 are top plan views similar to FIG. 8 showing the sequential steps in slitting the bun in preparation for filling the prepared slit or cavity with processed food.

FIG. 15 is a perspective view of the bun having been slit after the final step shown in FIG. 14.

FIG. 16 is a section view in the direction of arrows 16-16 in FIG. 15.

FIG. 17 is a section view in the direction of arrows 17-17 in FIG. 15.

FIGS. 18 to 23 show an enlarged portion of the invention in FIG. 2 depicting the sequential filling of the slit formed within the bun with processed food from a food package 18.

FIG. 24 is a section view of the bun filled with processed food ready for consumption.

Exemplary embodiments are illustrated in reference figures of the drawings. It is intended that the embodiments and figures disclosed herein are to be considered to be illustrative rather than limiting.

### DETAILED DESCRIPTION OF THE INVENTION

### Nomenclature

10. food dispensing apparatus
12. housing
14. case
16. bun transfer drawer
18. food package
20. roller access opening
22. squeezing rollers
24. working surface
26. upright drawer panel
28. housing interior
30. bun pocket forming mechanism
32. drive motor
34. control arm
36. cutting disc
38. drive pin
40. support block
42. stationary guide pin
44. roller drive
46. drive belt
48. sealed food bag
48a. empty food bag
50. sealing flange
50a. lead flange
50b. trailing flange
52. sandwich food
52a. sandwich food
54. slot
56. open end

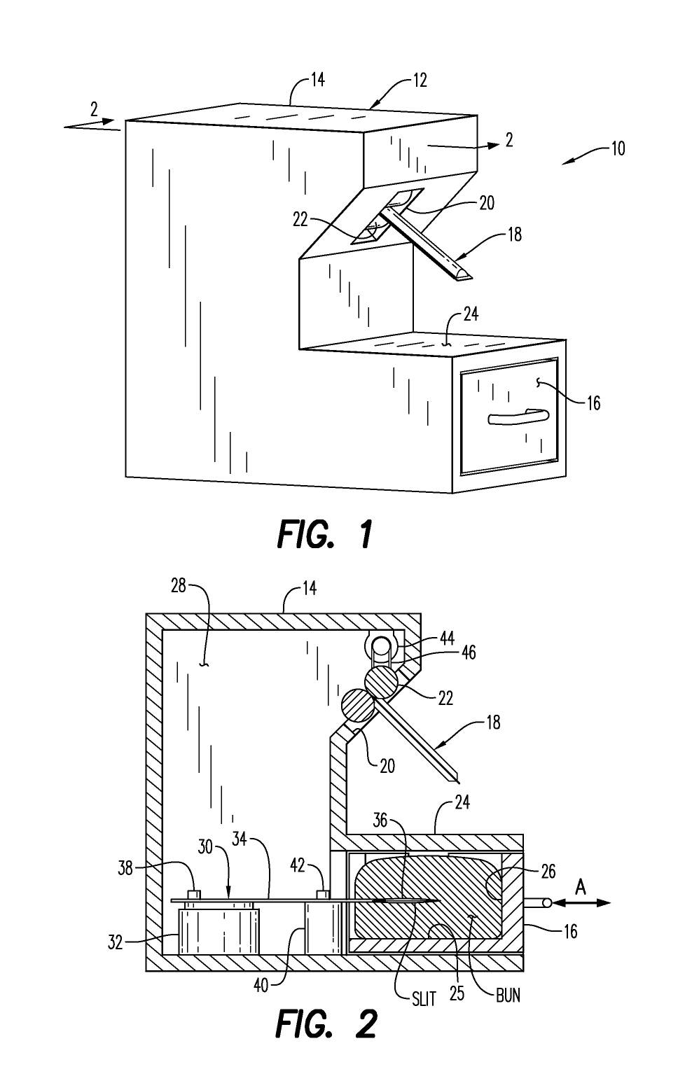

Referring now to the drawings, and firstly to FIGS. 1 to 7, the invention is there shown generally at numeral 10 in FIG. 1 and includes a housing 12 formed of suitable molded plastic or metal material, a bun pocket forming mechanism 30 mounted within the interior volume 28 of the housing 12, and a bun transfer drawer 16. In one aspect, the invention further includes a prepackaged quantity of processed food in a variety of forms held in a sealed food package 18.

The bun transfer drawer 16 is slidably engageable within the housing case 14 and positioned below a horizontal working surface 24 of the housing 12. The bun transfer drawer 16 is openable and closable in the direction of arrow A so that an uncut bun may be positioned atop the bottom 25 of the drawer 16 when the drawer 16 is opened. By closing the drawer 16 and the bun is carried into contact with the cutting disc 36 of the bun pocket forming mechanism 30 described in more detail herebelow.

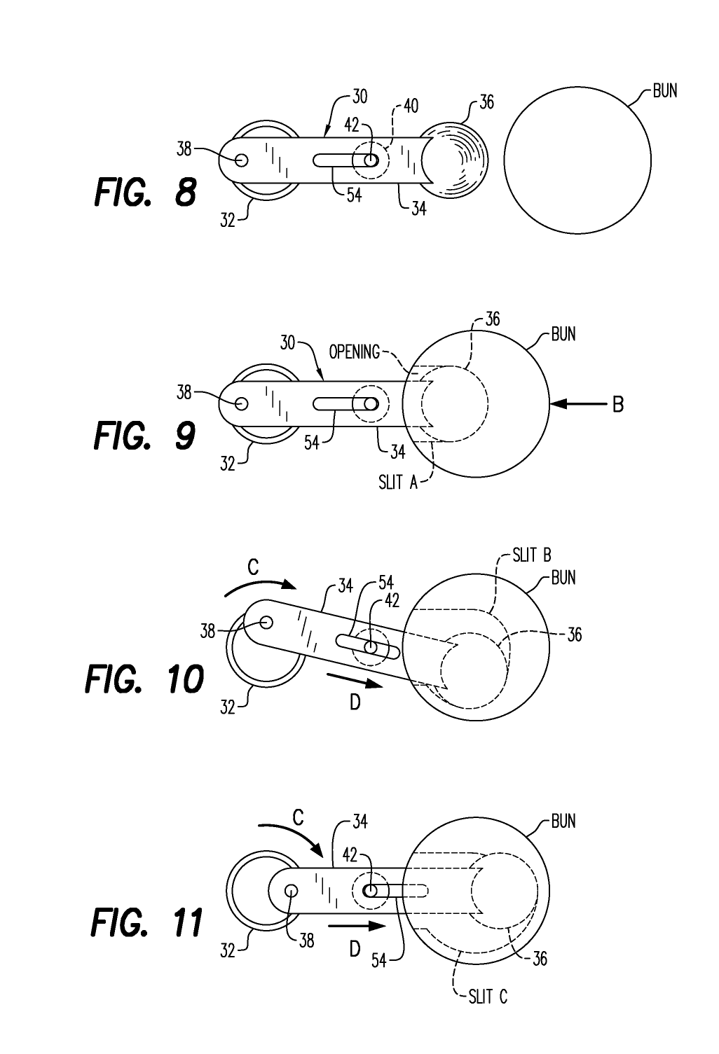

The bun pocket forming mechanism 30 includes a drive motor 32 mounted atop the floor of the case 14 within the interior volume 28. As also seen in FIG. 8, the bun pocket forming mechanism 30 also includes a stationary support block 40 mounted atop the floor of case 14. An elongated control arm 34 is pivotally connected to a drive pin 38 at one end thereof while also being supported at a mid-portion thereof atop support block 40 wherein an elongated slot 54 is fitted over stationary guide pin 42 for slidable translation of the control arm 34 thereover.

Affixed to the opposite end of the control arm 34 is a cutting disc 36 having sharpened edges therearound. The entire arrangement of control arm 34 and cutting disc 36 is preferably flat. However, the cutting disc 36 may also be offset vertically as desired for adjustability in bun thickness.

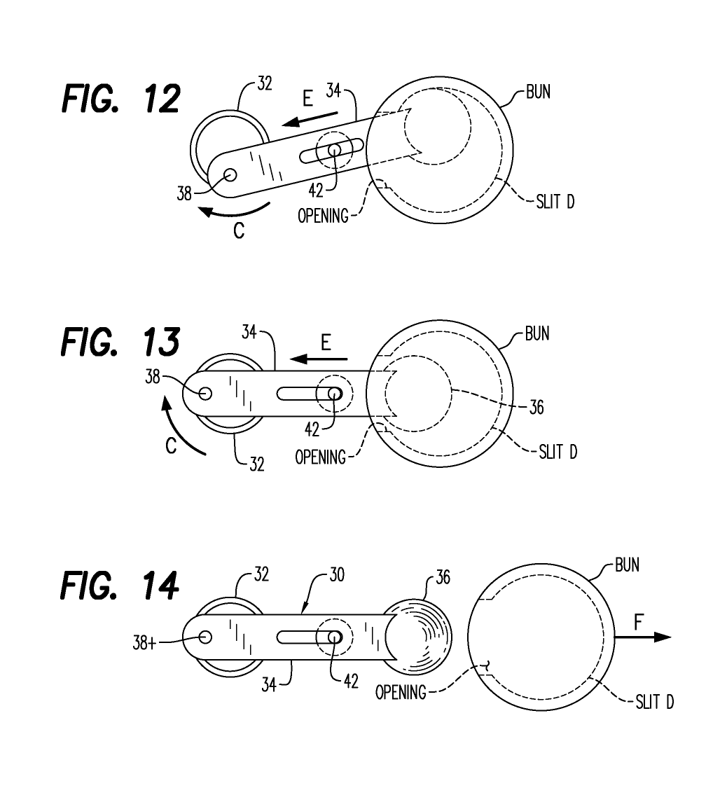

As seen schematically in FIGS. 8 to 14, as the bun is moved in the direction of arrow B in FIG. 9 by closing of the drawer 16 with the bun positioned therein, the drive motor is energized so that the drive pin begins to rotate in the direction of arrow C. Because the elongated slot 54 is secured around the stationary guide pin 42, movement of the cutting arm 34 causes the cutting disc 36 to move back and forth from the horizontal at rest position shown in FIG. 8 to one extreme of the cutting motion shown in FIG. 10 to the other extreme position of cutting motion shown in FIG. 12.

This back and forth motion of the cutting disc 36 as the bun is moved inwardly in the direction of arrow B causes the sequential forming of the initial cut into the bun wherein slit A is formed to the next stage of slit formation in FIG. 10 to form slit B, then slit C is formed in FIG. 11 with a continued articulated movement of the cutting arm 34 and movement in the direction of arrow D. During the next 180° rotation of the drive pin 38 as seen in FIGS. 12 and 13, the remainder of the slit is formed and defining slit D with the movement of the control arm 34 in the direction of arrow E. Finally, in FIG. 13, the cutting disc 36 is, having completed the cutting of slit B, is withdrawn from the bun by movement of the now-slit bun in the direction of arrow F by the opening of drawer 16 in the direction of arrow A.

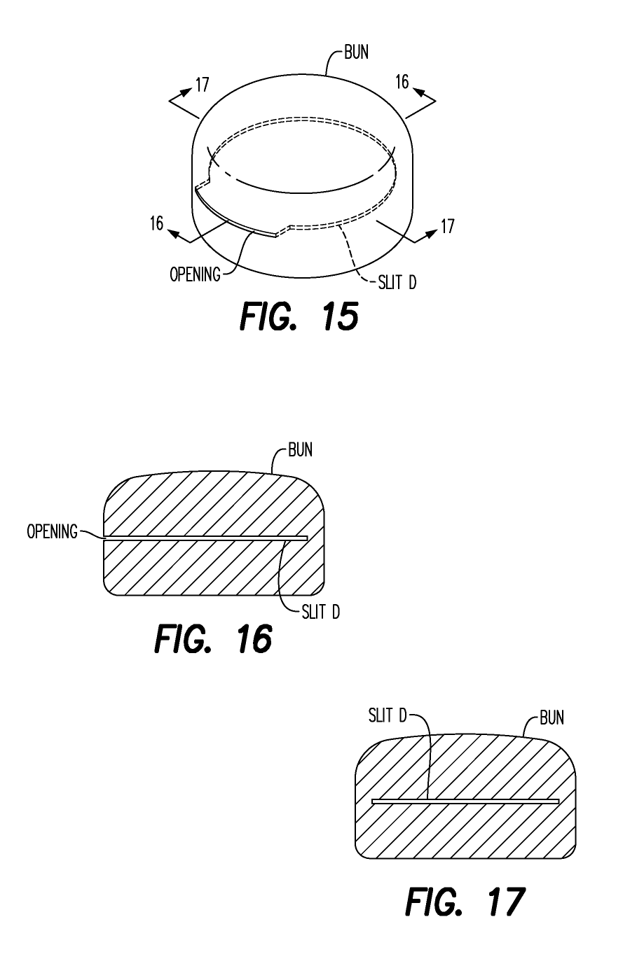

As seen in FIGS. 15 to 17, then, the bun has an opening and a slit D which has been formed without breaking through any of the sides of the bun except for the opening, the use of which will be described herebelow.

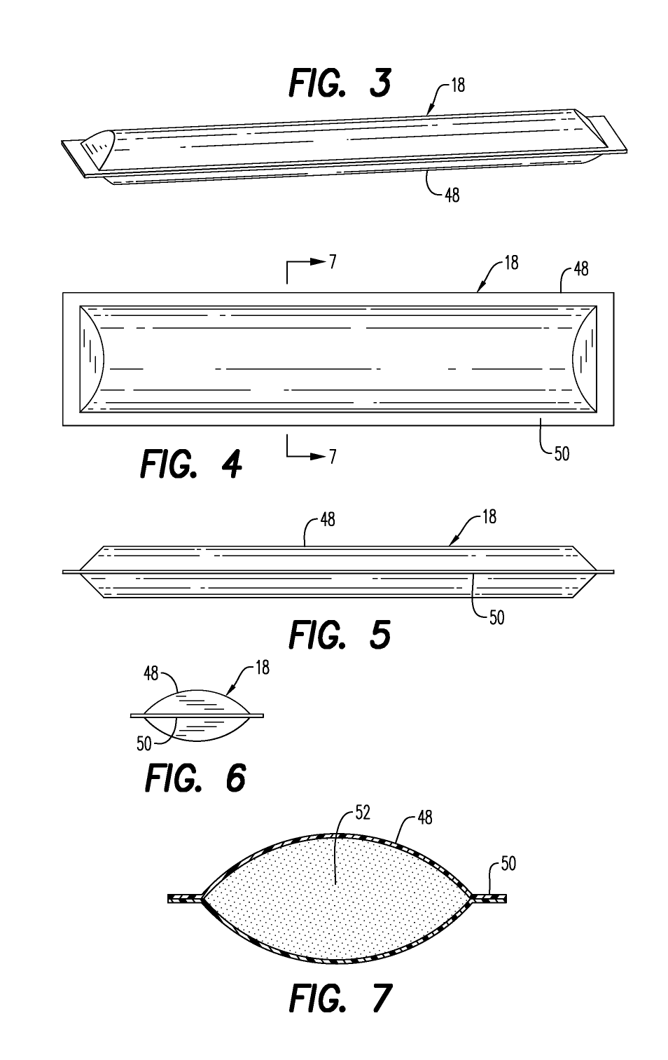

Referring now to FIGS. 3 to 7, the food package 18 is formed of an outer flexible plastic or metallic sealed food bag 18 having an elongated, slender configuration and an outwardly extending sealing flange 50 to ensure a completely sealed package and, for purposes described herebelow. A selected quantity of processed sandwich food 52 is sealed within the interior of the food bag 48, the only requirement being that the sandwich food 52 be capable of being squeezed or expressed from one opened end of the food bag 48 in a manner described herebelow.

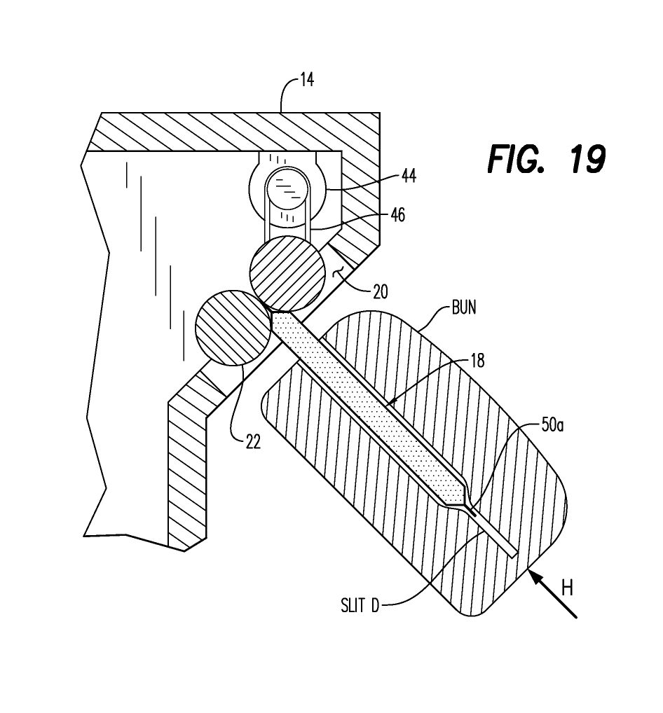

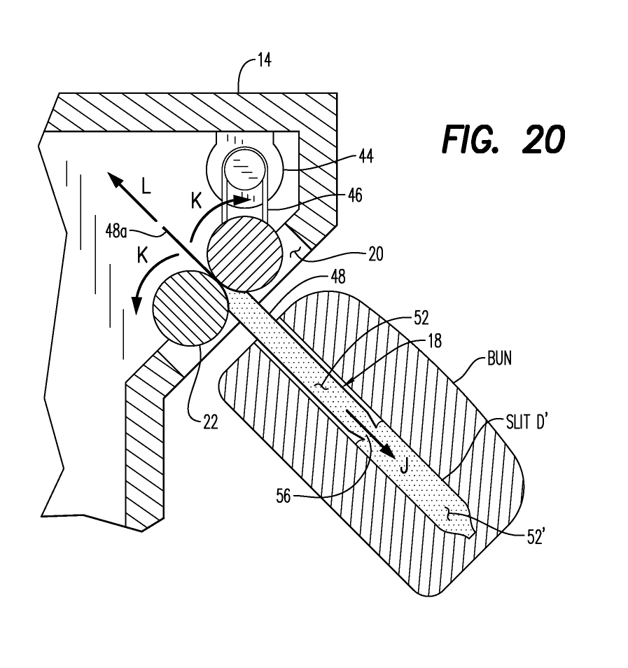

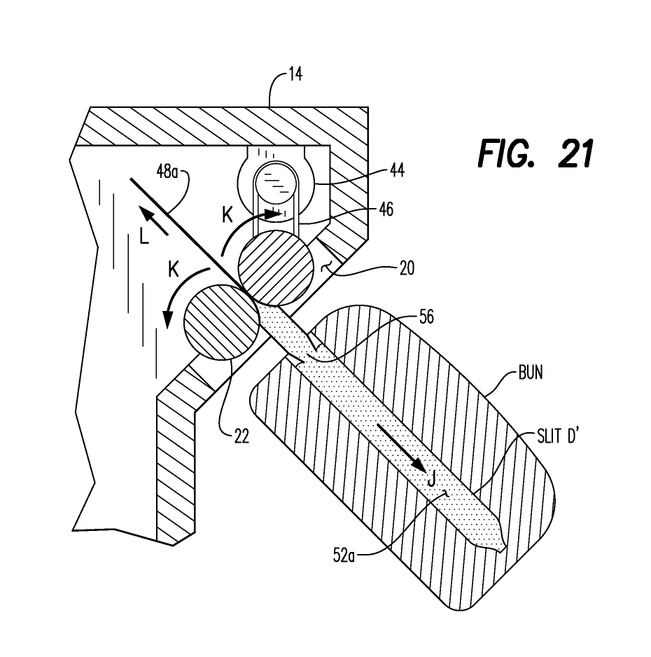

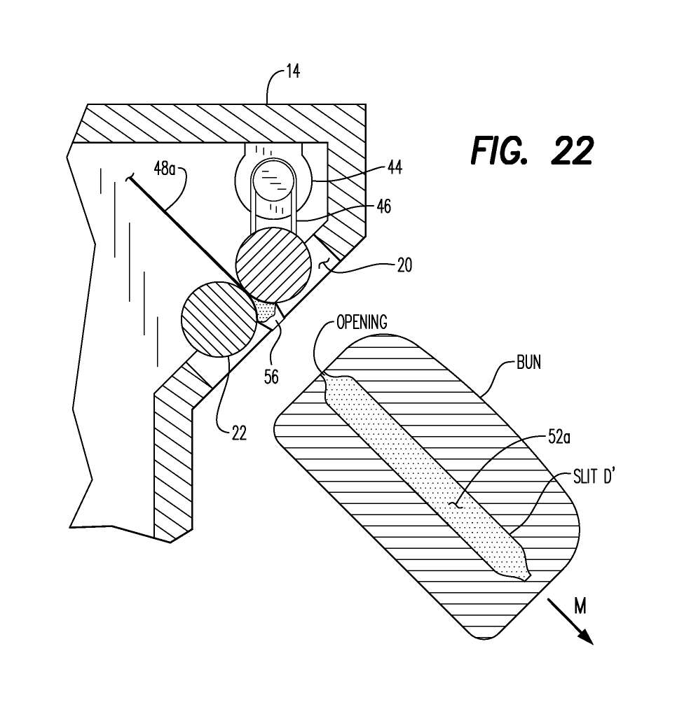

Referring now to FIGS. 19 to 24, the sequence of introducing the sandwich food 52 into slit D of the bun is thereshown. A roller access opening 20 is formed into the case 14 so as to provide clearance for a pair of opposing squeezing rollers 22 secured in proximity to and preferably within the roller access opening 20. These rollers 22 are rotatably driven in the direction of either arrows K or K′ (described herebelow) by a drive belt 46 operably connected to a roller drive 44 connected to the upper interior surface of the case 14.

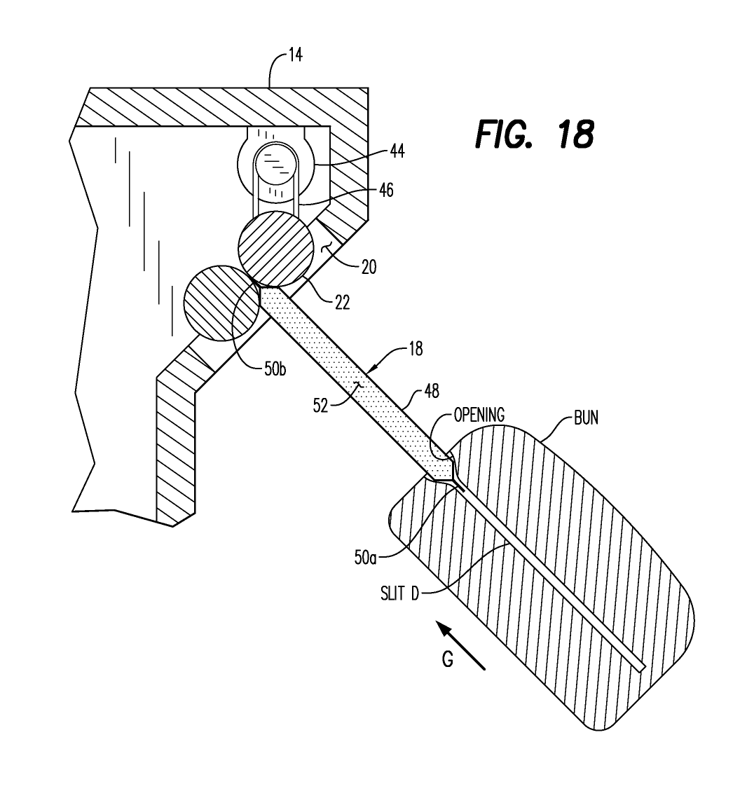

Best seen in FIG. 18, then, one end 50b of the sealing flange 50 is inserted between the rollers 22.

Then in FIG. 18, the bun is moved in the direction of arrow G so that the opposite end 50a of the sealing flange 50 is inserted through the opening of the bun into the slit B. As seen in FIG. 19, the bun is continued in its movement in the direction of arrow H until a substantial portion of the length of the food package 18 is inserted into the slit B.

The steps of expressing the sandwich food 52 from the interior of the food bag 48 is accomplished by the operation of the rollers 22 in the direction of arrow K which causes the food bag 48 to be drawn in the direction of arrow A through the rollers 22. In doing so, the sandwich food is expressed from the open end 56 of the food bag 48 so that the sandwich food moves into the slit B in the direction of arrow J.

Note that the open end 56 of the food bag 48 may be accomplished either by slicing the lead flange 50a or by providing a line of weakness thereacross so that the pressure created by the rollers 22 will rupture the line of weakness automatically, allowing the sandwich food 52a to fill the expanded slit B′.

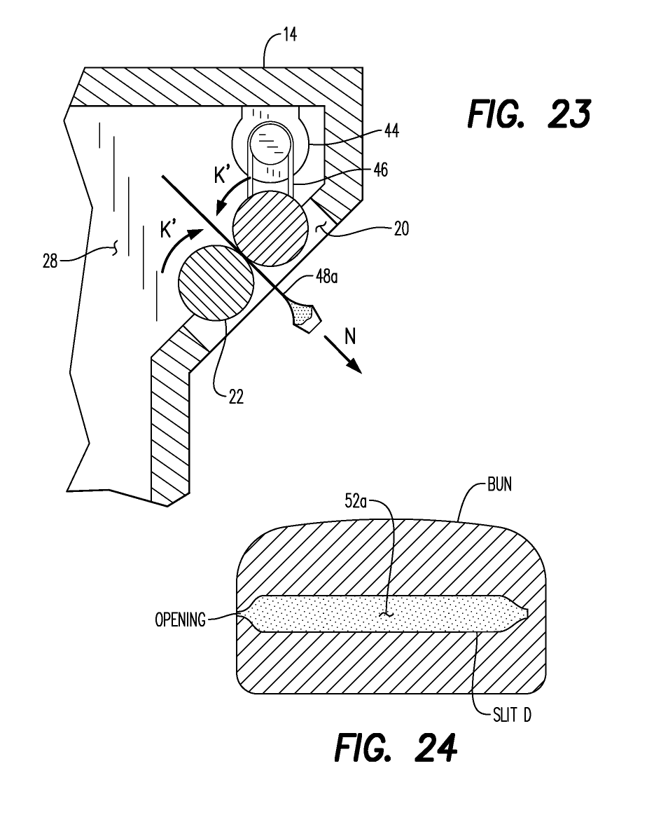

As seen in FIG. 23, once all of the sandwich food 52a has been forced into the expanded slit B′ of the bun, the rollers 22 are reversed and rotated in the direction of arrow K′ so that the emptied food bag 48a will then be discharged in the direction of arrow N for disposal. It is at this point that the user may then thoroughly enjoy the sandwich produced by the slit bun and the sandwich food 52a which has been deposited into the expanded slit B′ through the opening produced by the bun pocket forming mechanism 30 described hereinabove.

While a number of exemplary aspects and embodiments have been discussed above, those of skill in the art will recognize certain modifications, permutations and additions and subcombinations thereof. It is therefore intended that the following appended claims and claims hereinafter introduced are interpreted to include all such modifications, permutations, additions and subcombinations that are within their true spirit and scope.

1. A food dispensing apparatus comprising:
a housing including a bun pocket forming mechanism, a bun transfer member, and a pair of opposing driven rollers;
said pocket forming mechanism including a motor-driven articulating cutting disc which extends into and forms a food receiving slit into a bun placed onto said bun transfer mechanism;
said rollers adapted in size and spacing to receive and squeeze food from an elongated food package opened at a distal end thereof into the food receiving slot of the bun.

2. A food dispensing apparatus comprising:
a housing including a bun pocket forming mechanism, a bun transfer member, and a pair of opposing driven rollers;
said pocket forming mechanism including a motor-driven articulating cutting disc movable back and forth while a bun is movable on said bun transfer mechanism to position the bun into cutting engagement with said cutting disc to form a food receiving slit into the bun;
said rollers adapted in size and spacing to receive and squeeze food from an elongated food package opened at a distal end thereof into the food receiving slot of the bun.

3. A food dispensing apparatus comprising:
a housing including a bun pocket forming mechanism, a bun transfer member, and a pair of opposing driven rollers;
an elongated flexible food package having sealed edges and being filled with sandwich food;
said pocket forming mechanism including a motor-driven articulating cutting disc which moves back and forth, said cutting disc having a diameter smaller than that of a sandwich bun;
said bun transfer mechanism receiving and moving the bun into cutting engagement with said cutting disc to form a food receiving slit into the bun;
said rollers adapted in size and spacing to receive and squeeze food from said food package which has been opened at one end thereof into the food receiving slot of the bun.
